(19) United States
(12) Patent Application Publication
(10) Pub. No.: US 2007/0100968 A1
(43) Pub. Date: May 3, 2007

(54) Proprietary configuration setting for server to add custom client identity

(75) Inventors: Zoltan Ordogh, Tampere (FI); Tao Haukka, Oulu (FI); Kaisu Mattila, Oulu (FI); Jari Valimaa, Lempaala (FI); Janne Vento, Tampere (FI); Tommi K. Kangas, Oulu (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/261,161

(22) Filed: Oct. 27, 2005

(51) Int. Cl. G06F 15/177

(52) U.S. Cl. 709/220

(57) ABSTRACT

The invention relates to a method for updating a wireless device connected to a cellular network utilizing Instant Messaging and Presence Service protocol (IMPS) defined by open Mobile Alliance. In the method a server connected to the cellular network transmits a configuration message to the wireless device including a CIDPrefix, which includes a provider specific identity string. The wireless device which has received the configuration message adds to the provider-specific identity string separation marks and a supplier-specific internal identity string. After that the wireless device uses this concatenated identity string as a ClientID with the server which sent the configuration message. The invention relates also to a configuration message, wireless device, server and device management system utilizing the method. The invention relates also to computer programs implementing the method in a server and a wireless device.

### TECHNICAL FIELD OF THE INVENTION

The invention relates to a proprietary configuration setting utilized in a wireless device management system. The invention also relates to a method and a wireless terminal utilizing said proprietary configuration setting. The invention relates also to a computer program product implementing the proprietary configuration setting in a wireless terminal.

### BACKGROUND OF THE INVENTION

The Open Mobile Alliance (OMA) provides an open forum to standardize and certify various technologies utilized in wireless telecommunication environment. One of these technologies is IMPS (Instant Messaging and Presence Service). IMPS is a technology that allows exchanging instant messages and presence information between users no matter what kind of clients they are using, be it a PC, a laptop or a mobile phone for example. IMPS is often referred to as Wireless Village (WV) since the Wireless Village Initiative produced the original protocol. OMA has released two IMPS protocol versions IMPS v1.1 and IMPS v1.2, while v1.3 has reached candidate status in October 2005.

The Open Mobile Alliance provides also another technology, OMA Device Management, which is a standardised technology that provides general framework and methods to alleviate interoperability problems related to management of heterogeneous world of mobile devices. OMA DM comprises a multi-administrator model, management sessions between Device Management Server (hosted by administrator) and Managed Device, management tree as an abstraction of managed asset (meant for addressing and access control purposes) and management commands manipulating the management tree (e.g. get, add, delete, exec addressed to leafs or nodes in the Management Tree).

Mobile phone suppliers have received requirements from various server implementers/service providers regarding content of a ClientID (Client IDentity), which is utilized in OMA based wireless networks. There exists a need to include various data fields inside the ClientID, which unfortunately often would be operator specific. It would not be a big problem if there were only a few service providers, which want to utilize custom data, which is usually hard-coded in the devices. However, in that case a wireless device cannot be configured remotely from an access point.

Also the hard-coded custom ClientIDs have become a problem because they require customized appliance variants for different operators. In order to reduce the number of variations, it would be desirable that the operator-specific ClientID part could be dynamically adjustable.

Also the software of the wireless device must be updated if it will communicate with an access point, i.e. a server having a ClientID unknown to the wireless device.

OMA IMPS standard defines a ClientID to be either a MSISDN (Mobile Subscriber ISDN) definition or a URI (Uniform Resource Identifier) definition—however, in v1.3 of the IMPS specifications only URIs are allowed. Most client implementations are using the URI, since it is almost a free-form string and a lot of information that is necessary for the client's operation may be included in it. It is important to appliance suppliers that format of the string is defined so that it can be implemented easily, without losing the freedom of inserting supplier-specific information in the ClientID as well as the service provider-specific information, when desired.

### SUMMARY OF THE INVENTION

The object of the present invention is to provide a provider-specific client identity string value for remotely updating a configuration of a wireless device utilizing OMA Device Management (OMA-DM).

By the invention it is possible to implement a uniform configuration message string without loosing the freedom of inserting implementation-specific and provider-specific information in the ClientID when it is needed. The provider-specific ClientID part according to the invention is dynamically adjustable.

The objects of the present invention are fulfilled by providing a method for configuring a wireless device through a wireless network utilizing OMA Device Management (OMA-DM), the method comprising the steps of:
receiving a configuration message in the wireless device,
interpreting the configuration message in the wireless device, and
concatenating a received provider-specific identity string and a supplier-specific identity string of the wireless device when said provider-specific identity string has been detected in the configuration message, and saving it in the wireless device as a concatenated client identity string.

The objects of the present invention are fulfilled also by providing a method for configuring a wireless device, the method comprising the steps of:
sending from a server to a wireless device a configuration message based on uniform resource identifier definition comprising a provider-specific identity string,
receiving a concatenated client identity string from the wireless device whereto the server sent the configuration message, and
utilizing the concatenated client identity string in any communication between the wireless device and server.

The objects of the present invention are fulfilled also by providing a method for configuring a wireless device in which method:
a server sends to a wireless device an OMA Device Management configuration message comprising a CIDPrefix,
the wireless device receives said CIDPrefix,
the wireless device interprets the CIDPrefix,
the wireless device concatenates the CIDPrefix and an internal client identity of the wireless device by placing two hash marks between them, and
the wireless device saves it as a ClientID of the wireless device.

The objects of the present invention are fulfilled also by providing an OMA Device Management (OMA-DM) configuration message utilizing a uniform resource identifier from a server to a wireless device, the configuration message comprising a CIDPrefix which includes a provider-specific identity string.

The objects of the present invention are fulfilled also by providing a client-specific identity string included in an OMA Device Management (OMA-DM) message from a wireless device to a server, which message utilizes a uniform resource identifier, said client-specific identity string comprising:
a provider-specific identity part,
a separator part after the provider-specific identity part, and
a supplier-specific identity part after the separator part.

The objects of the present invention are fulfilled also by providing a wireless device comprising:
a means for receiving a provider-specific identity string included in an OMA Device Management (OMA-DM) configuration message from a server,
a means for interpreting the received configuration message,
a means for concatenating the received provider-specific identity string and a supplier-specific client identity string of the wireless device when said provider-specific identity string has been detected, and
a means for using the concatenated client identity string in communication with the server, which sent the configuration message.

The objects of the present invention are fulfilled also by providing a server for updating a configuration of a wireless device through a wireless network utilizing OMA Device Management (OMA-DM), the server comprising:
a means for sending to the wireless device a configuration message utilizing uniform resource identifier comprising a provider-specific identity string, and
a means for receiving from the wireless device a concatenated client identity string comprising:
   the provider-specific identity string,
   a separator part after the provider-specific identity string value, and
   a supplier-specific internal identity string of the wireless device after the separator part.

The objects of the present invention are fulfilled also by providing a device management system for updating a configuration of a wireless device utilizing OMA Device Management (OMA-DM), the device management system comprising:
a wireless network utilizing OMA Device Management procedure, the wireless network comprising:
   access points capable of sending to a wireless device a uniform resource identifier based configuration message comprising a provider-specific identity string,
   wireless terminals which are capable of:
      receiving a configuration message addressed to it,
      interpreting said provider-specific identity string included in the configuration message, and
      when said provider-specific identity string has been detected concatenating the received provider-specific identity string and a supplier-specific identity string of the wireless device as a concatenated client identity string, and
      using the concatenated client identity string in communication with the access point, which sent the configuration message.

The objects of the present invention are fulfilled also by providing a computer program product for a wireless device to configurate a wireless device utilizing OMA Device Management (OMA-DM), the computer program product comprising:
a computer-readable code means for receiving a provider-specific identity string included in a configuration message from a server to the wireless device,
a computer-readable code means for interpreting said configuration message,
a computer-readable code means for concatenating the provider-specific identity string and a supplier-specific identity string when said provider-specific identity string is detected, and
a computer-readable code means for using the concatenated client identity string in communication with the server, which sent the configuration message.

The objects of the present invention are fulfilled also by providing a computer program product for a server to update a wireless device utilizing OMA Device Management (OMA-DM), the computer program product comprising:
a computer-readable code means for creating a provider-specific identity string to be included in a configuration message from the server to the wireless device, and
a computer-readable code means for receiving a concatenated client identity string from the wireless device, the concatenated identity string comprising:
   the provider-specific identity string,
   a separator part after the provider-specific identity string value, and
   a supplier-specific internal identity string of the wireless device after the separator part.

According to the present invention a ClientID, which consist of two identity parts concatenated with each other, is utilized in a cellular network utilizing OMA Device Management (OMA-DM). The device identities are defined by URI. The concatenated client identity string according to the invention comprises a provider-specific identity string part, a separator part and supplier-specific identity string part. When a wireless device receives from a server a configuration message including the provider-specific identity string, it modifies the received identity string to a concatenated client identity by adding first two hash marks after the provider-specific identity string and after said hash marks also a supplier-specific internal identity string. The wireless device uses the concatenated client identity string always when it is in contact with the server which has sent its own provider-specific identity string to the wireless device.

Further scope of applicability of the present invention will become apparent from the detailed description given hereafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and accompanying drawings which are given by way of illustration only, and thus are not limitative of the present invention and wherein

FIG. 1 shows a schematical representation of wireless environment where the invention is utilized;

FIG. 2a shows a management tree chart including an extension according to the invention;

FIG. 2b shows an extract of the Management Object DDF listing including an extension according to the invention;

FIG. 3 shows an exemplary flow chart including main stages of the method according to the invention; and

FIG. 4 shows the main parts of a wireless device according to the invention by way of example.

### DETAILED DESCRIPTION

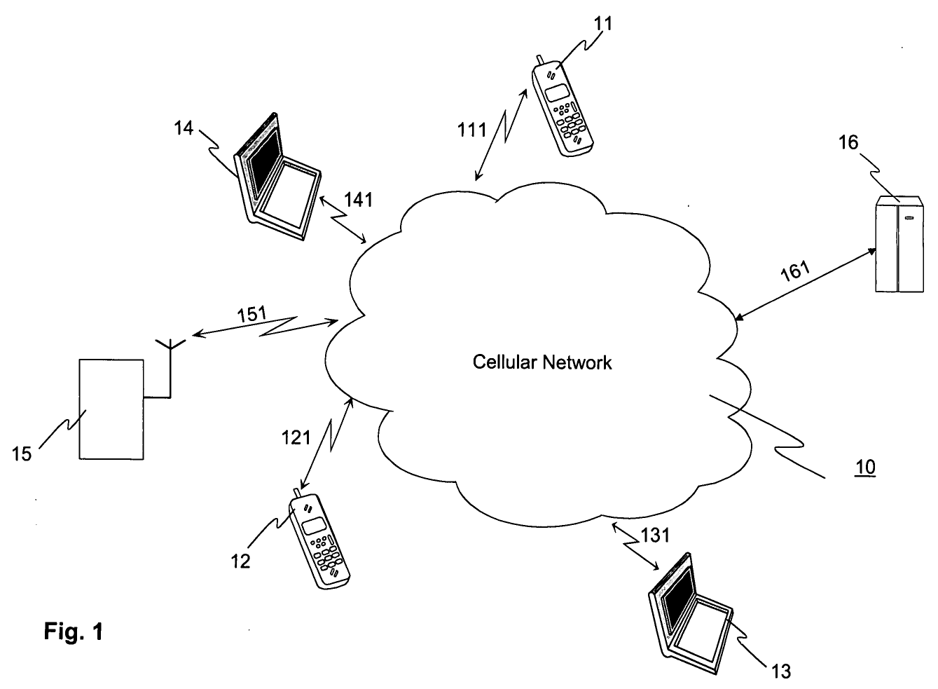

FIG. 1 illustrates an example of a telecommunication environment where the present invention can be applied. In the example the invention is utilized in a cellular network 10. The cellular network 10 can be for example a GSM (Global system for Mobile communication), GPRS (General Packet Radio Service), EDGE (Enhanced Data rates for GSM Evolution), UMTS (Universal Mobile Telecommunications Services) or CDMA (Code Division Multiple Access) network. Naturally the depicted cellular network 10 can comprise also of a combination of the above-mentioned cellular network types.

The cellular network 10 comprises a network core part (not shown in detail in FIG. 1) which takes care of the administration of the cellular system. Some examples of components of the network core part are mobile switching centres, base station sub-systems and base stations. The role of the base stations in this context is to provide a radio path to each mobile device 11, 12, 13 and 14 attached to the cellular network 10 in FIG. 1.

Different kind of electronic devices can be connected wirelessly to the cellular network 10. Some examples are depicted in FIG. 1. Reference 11 in FIG. 1 illustrates an example of a GSM phone according to the prior art connected to the cellular network 10 with a circuit-switched connection 111. Another mobile phone 12 can advantageously utilize a packet-switched connection 121 instead of a circuit-switched connection when connected to the cellular network. An exemplary laptop computer 13 can also be connected to the cellular network 10 advantageously by a packet-switched connection 131. Reference 14 illustrates a PDA (Personal Digital Assistant) comprising a suitable network adapter for connecting it wirelessly to the cellular network 10, reference 141.

To the cellular network 10 can be connected also particular wireless devices 15 which are utilized in M2M connections (Machine to Machine). The M2M wireless device 15 comprises advantageously at least a means for transmitting and receiving messages by a wireless connection 151 comprising either a circuit-switched connection or packet-switched connection.

Reference 16 in FIG. 1 denotes a service provider's server, which is advantageously connected to the cellular network 10 by a fixed connection 161. Each of the above-mentioned wireless devices 11-15 can either receive messages from the server 16 or send message to the server. In this context the server can also be called as an access point. The service provider can update the server 16 with new features or services. If the new feature included in the server 16 requires an update also in a mobile device for a certain service to be available, the mobile device must be configured in a requisite way. This can be achieved with a configuration message, which the server 16 sends to a particular mobile device 11-15.

The configuration message comprises an attribute according to the invention called CIDPrefix. The syntax of the CIDPrefix follows the Client syntax defined in the OMA IMPS standard. To fulfil requirements of the present invention the server 16 advantageously comprises a suitable software program for creating the CIDPrefix, for including it in configuration messages and also for utilizing a concatenated client identity string, which includes the CIDPrefix according to the invention, in communication between selected mobile devices.

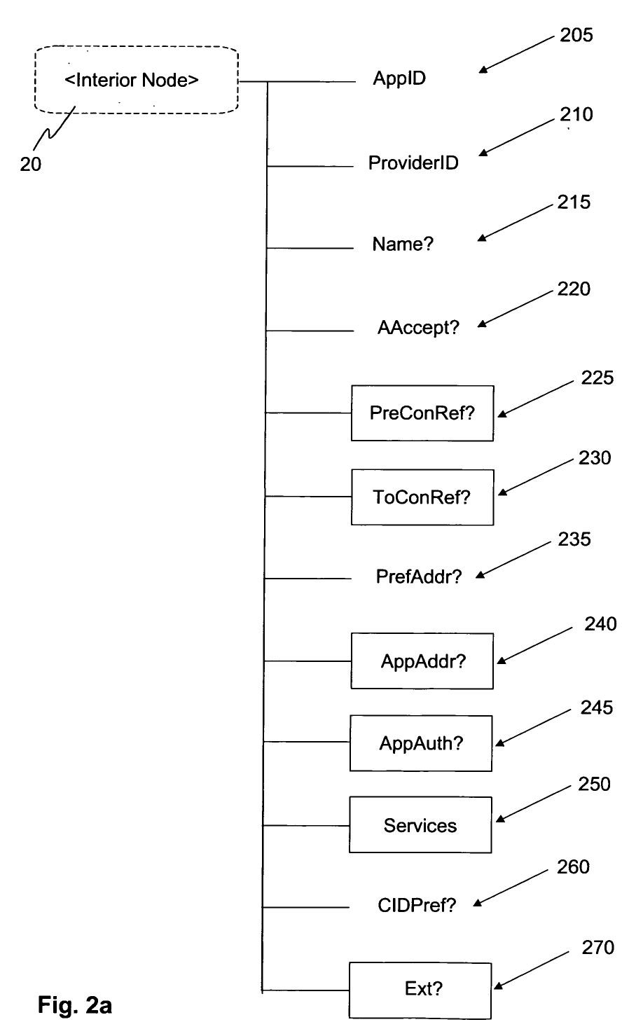

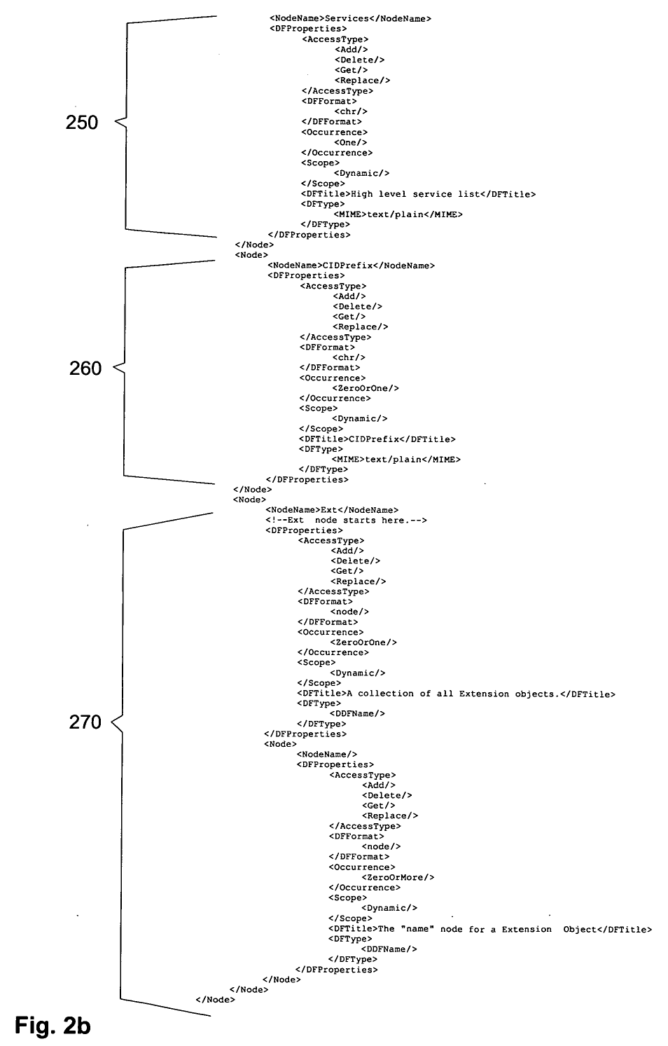

FIGS. 2a and 2b depict a management tree of a configuration message according to the invention. FIG. 2a depicts the main management objects and FIG. 2b depicts an extract of three management object DDFs in more detail, especially the CIDPrefix according to invention.

The management tree in FIG. 2a comprises an interior node 20 with eleven attributes included in a configuration message according to the invention. Reference 205 (AppID) discloses an application identity, which identifies a type of an application service available at a described service access point (SAP). Reference 210 (ProviderID) discloses a provider identifier for the SAP and reference 215 (Name?) discloses a user-displayable name for the SAP.

Further reference 220 (AAccept?) discloses accepted content types that the SAP is able to receive from the client. Reference 225 (PreConRef?) discloses preferred connection references and reference 230 (ToConRef?) is an interior node disclosing a collection of ToConRef objects comprising connection references.

Further reference 235 (PrefAddr?) discloses a preferred address of an application server. Reference 240 (AppAddr?) discloses an interior node which is used to allow multiple addresses to be defined for applications. Reference 245 (AppAuth?) is an interior node comprising authentication information to be used with the SAP. Reference 250 (Services) includes a high-level service list.

Reference 260 includes the CIDPrefix according to the invention and reference 270 (Ext?) is an interior node disclosing a collection of all extension objects.

FIG. 2b discloses a description of three of the above-mentioned attributes in more detail. Attributes 250 (Services) and 270 (Ext?) are comprised in the prior art. Attribute 260, CIDPrefix, represents the present invention which enforces a mobile device, which has received the configuration message, to use a concatenated client identity according to the invention with a server which has sent a configuration message according to the invention to the mobile device. The basic structure of the CIDPrefix 260 follows the syntax defined in OMA IMPS standard. The OMA IMPS standard allows two hundred characters to be used in URI-based ClientIDs. Therefore CIDPrefix according to the invention advantageously has a maximum length of one hundred characters. The rest of the remaining character numbers are reserved for the supplier-based ID part of the concatenated client identity string. If the supplier-based ID part is longer than 99 characters, it must be truncated.

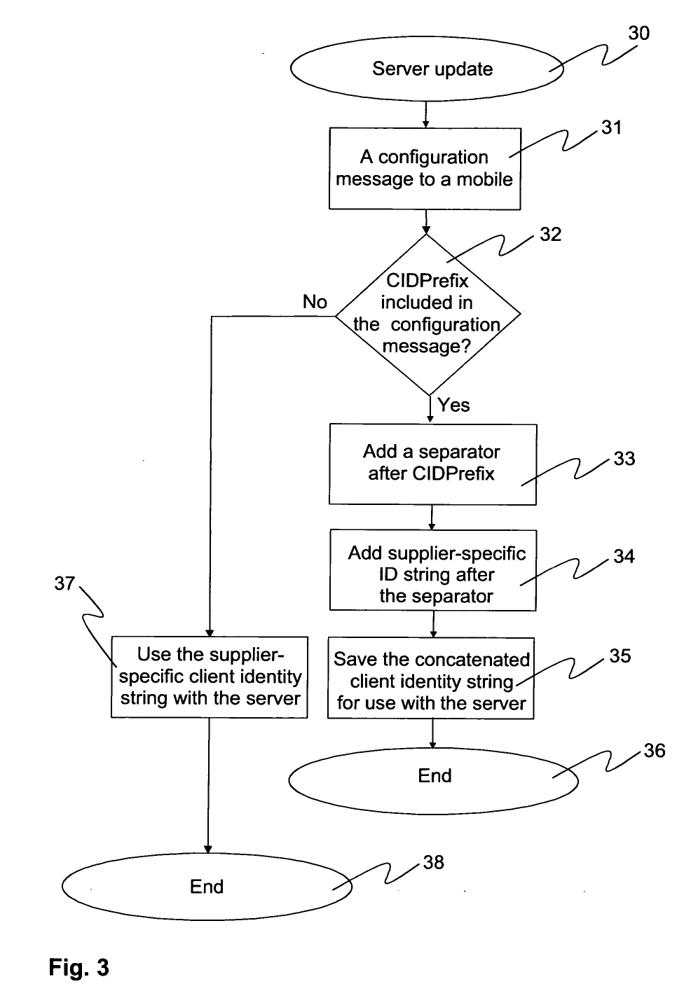

FIG. 3 depicts the main procedural steps when a server 16, including a software according to the invention and utilizing OMA Device Management, includes a CID-Prefix 260 in a configuration message according to the invention directed to a particular mobile device, for example mobile phone 11. The use of the invention is possible if the ClientID is URI-based.

The implementation process starts in step 30 where an update of a service is accomplished in the server 16. After the update the server 16 can offer either an improved service or a completely new service.

In step 31 the server 16 transmits a configuration message, which includes a CID-Prefix string 260 according to the invention, to a particular mobile 11. The mobile phone 11 receives the sent configuration message.

An example of a CIDPrefix according to the invention belonging to Cingular and sent to a mobile device is:
Cingular:J2ME:4:5:YAHOO:IAK@#MGSA5.

In step 32 the particular mobile phone 11 checks if the received configuration message includes a CIDPrefix according to the invention. If the configuration message does not include the CIDPrefix, alternative “No”, the configuration process continues to step 37. In step 37 the mobile phone 11 sets as default to utilize a normal supplier-specific internal client identity string when being in connection with the server 16. After that the configuration process ends to step 38. In step 38 the mobile phone 11 is in a mode where it uses in communication with the server 16 only the supplier-specific internal client identity.

The supplier-specific Internal ClientID has advantageously the following formula:
“wv:” <Software name><Software version>“$”(<ProcessID>|<ApplicationID>|<random number>)“@<Supplier name>”<Phone model>.

An example of a supplier-specific Internal ClientID is a Nokia-specific Internal ClientID, which has a formula:
wv:IM01$12345@NOK.3650.

If the check in step 32 gives a positive answer, “Yes”, in step 33 the mobile phone 11 adds first a separator part after the received CIDPrefix. In step 34 it further adds a supplier-specific client identity string after the separator part. Advantageously the separator part comprises two hash marks. The formula of the concatenated ClientID according to the invention is:
ClientID=[<CIDPrefix>+“##”]<Internal ClientID>.

As an example of a concatenated Singular and Nokia client identity using the above-mentioned provider-specific and supplier-specific client identities which can be used with a Cingular server (i.e. an access point) is:
Cingular:J2ME:4:5:YAHOO:IAK@#MGSA5##wv:IM01$12345@NOK.3650.

The mobile phone 11 saves the concatenated ClientID according to the invention in step 35. The mobile phone 11 uses the concatenated ClientID always when it communicates with the server 16 from which the mobile phone 11 received the configuration message including the CIDPrefix according to the invention.

After that the configuration process in the mobile phone 11 continues to step 36 where it ends. In step 36 the mobile phone 11 is in a mode where it uses in any communication with the server 16 (i.e. a provider access point) only the concatenated client identity according to the invention.

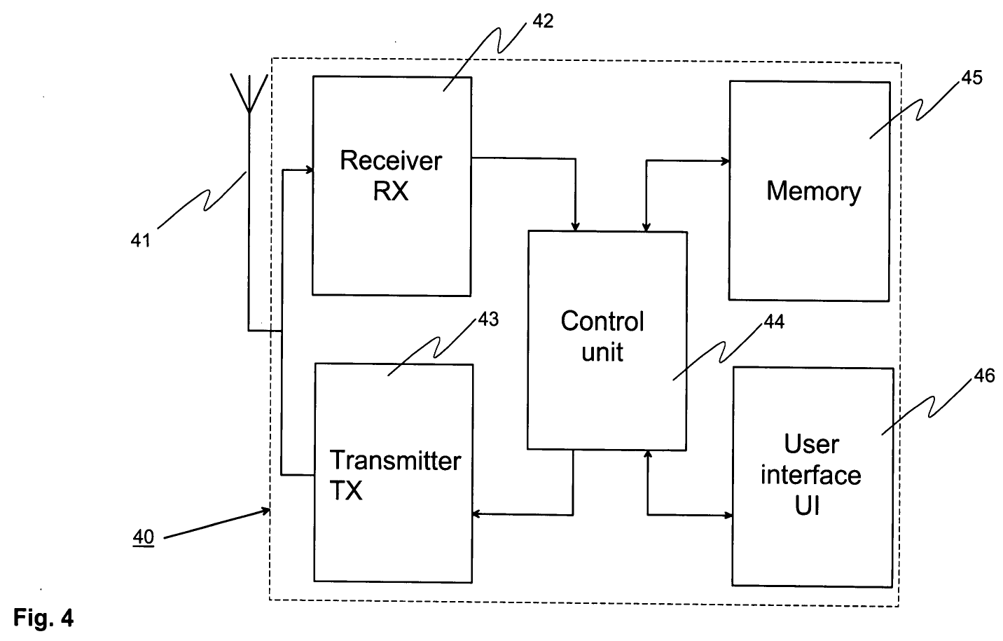

FIG. 4 shows, by way of example, the functional main parts of a wireless device 40 of a cellular network capable of utilizing the concatenated ClientID according to the invention. The wireless device 40 can be, for example, a GSM, GPRS or UMTS terminal device.

The wireless device 40 uses an antenna 41 in the transmission and reception of signals with the serving cellular network. The receiver means RX of the wireless device 40 are shown by reference 42. The receiver RX comprises prior art means for all messages or signals to be received. With the receiver means the wireless device receives massages from a server of a service provider. One possible message comprises configuration information from the server to the wireless device.

Reference 43 denotes the means of which the transmitter TX of the wireless device 40 is composed. All the signal processing measures required when operating with the cellular network are performed on the signal to be transmitted by the transmitter means 43. When the wireless device sends a message to a server, it uses either a supplier-specific internal ClientID or concatenated ClientID according to the invention. Which one of the two possibilities is selected depends on the last received configuration message from the server whereto the wireless device is sending a message.

In the terminal device 40 an essential part with regard to the utilization of the invention is the central processing unit 44 that controls operations of the transmitter 43 and receiver 42. It controls also the memory 45, in which the software application required in the implementation of the method according to the invention can advantageously be saved. The central processing unit 44 concatenates the provider-specific client identity with the supplier-specific client identity. After the concatenation the central processing unit saves the ClientID according to the invention in the memory 45.

The wireless device 40 can also comprise a user interface 46.

The use of the invention requires a software application to be installed in a wireless device 40. The software comprises software means for identifying a CIDPrefix according to the invention from a received configuration message. It also comprises software means for concatenating a provider-specific client identity with the supplier-specific internal client identity if the CIDPrefix is received. The software also comprises software means to make a decision to use in communication with the server either the supplier-specific internal ClientID or the concatenated ClientID according to the invention. The choice made by the software depends on the CIDPrefix; if it is received or not.

Also a server of a service provider needs software to utilize the invention. The software comprises software means for creating a CIDPrefix according to the invention. The software comprises also software means for transmitting the CIDPrefix to a particular wireless device. It also comprises software means for receiving and utilizing a concatenated client identity according to the invention which are received from the particular wireless device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for configuring a wireless device utilizing OMA Device Management protocol, the method comprising the steps of:
receiving a configuration message in the wireless device,
interpreting the configuration message in the wireless device, and
concatenating a received provider-specific identity string and a supplier-specific identity string of the wireless device when said provider-specific identity string has been detected in the configuration message, and saving it in the wireless device as a concatenated client identity string.

2. The method according to claim 1 wherein the concatenation comprises the steps of:
adding a separation part after the received provider-specific client identity string, and
adding a supplier-specific internal identity string after the separation part.

3. The method according to claim 2 wherein the separation part comprises two hash marks.

4. The method according to claim 2 wherein:
the provider-specific client identity string comprises at maximum one hundred characters, and
the supplier-specific internal identity string comprises at maximum one hundred characters.

5. A method for configuring a wireless device utilizing OMA Device Management protocol, the method comprising the steps of:
sending from a server to a wireless device a configuration message based on uniform resource identifier definition comprising a provider-specific identity string,
receiving a concatenated client identity string from the wireless device whereto the server sent the configuration message, and
utilizing the concatenated client identity string in any communication between the wireless device and server.

6. The method according to claim 5 wherein the concatenated client identity string comprises:
a provider-specific client identity string,
a separation part after a provider-specific client identity string, and
a supplier-specific internal identity string after the separation part.

7. The method according to claim 6 wherein the separation part comprises two hash marks.

8. The method according to claim 6 wherein:
the provider-specific client identity string comprises at maximum one hundred characters, and
the supplier-specific internal identity string comprises at maximum one hundred characters.

9. A method for configuring a wireless device in which method:
the wireless device receives an OMA Device Management configuration message comprising a CIDPrefix,
the wireless device interprets the CIDPrefix,
the wireless device concatenates the CIDPrefix and an internal client identity of the wireless device by placing two hash marks between them, and
the wireless device saves it as a ClientID of the wireless device.

10. The method according to claim 9 wherein the ClientID has the formula:
ClientID=[<CIDPrefix>+“##”+]<Internal ClientID>.

11. An OMA Device Management protocol configuration message utilizing a uniform resource identifier from a server to a wireless device, the configuration message comprising a CIDPrefix which includes a provider-specific identity string.

12. The configuration message according to claim 11 wherein the CIDPrefix comprises at maximum one hundred characters.

13. A client identity string included in OMA Device Management message from a wireless device to a server which message utilizes a uniform resource identifier, said client identity string comprising:
a provider-specific identity part,
a separator part after the provider-specific identity part, and
a supplier-specific identity part after the separator part.

14. The client identity string according to claim 13 wherein the supplier-specific internal client identity part comprises a CIDPrefix, which includes a provider-specific identity string.

15. The client identity string according to claim 13 wherein the separator part comprises two hash marks.

16. The client identity string according to claim 13 wherein the provider-specific client identity part comprises a provider-specific internal identity string.

17. The client identity string according to claim 13 wherein the client identity string has a formula:
ClientID=[<CIDPrefix>+“##”+]<Internal ClientID>.

18. A wireless device comprising:
a means for receiving a provider-specific identity string included in OMA Device Management configuration message from a server,
a means for interpreting the received configuration message,
a means for concatenating the received provider-specific identity string and a supplier-specific client identity string of the wireless device when said provider-specific identity string has been detected, and
a means for using the concatenated client identity string in communication with the server, which has sent the configuration message.

19. The wireless device according to claim 18 wherein the means for concatenating comprises:
a means for adding separation marks after the received provider-specific identity string value,
a means for adding the supplier-specific internal identity string of the wireless device after the separation marks, and
a means for saving the created concatenated client identity string in the wireless device.

20. The wireless device according to claim 18 wherein the wireless device when communicating with the server utilizes a ClientID having a structure:
ClientID=[<CIDPrefix>+“##”+]<Internal ClientID>.

21. The wireless device according to claim 18 wherein the wireless device is one of the following: a mobile phone, laptop computer, PDA or M2M terminal.

22. A server for updating a configuration of a wireless device by utilizing OMA Device Management protocol, the server comprising:
a means for sending to the wireless device a configuration message utilizing uniform resource identifier comprising a provider-specific identity string, and
a means for receiving from the wireless device a concatenated client identity string comprising:
the provider-specific identity string,
a separator part after the provider-specific identity string value, and
a supplier-specific internal identity string of the wireless device after the separator part.

23. The server according to claim 22 wherein the server includes in the configuration message a CIDPrefix as the provider-specific identity string.

24. The server according to claim 23 wherein the server further comprises a means for interpreting a received concatenated client identity having a formula:
ClientID=[<CIDPrefix>+“##”+]<Internal ClientID>
as a valid client identity for the wireless device which sent it.

25. A device management system for updating a configuration of a wireless device, the device management system comprising:
a wireless network utilizing OMA Device Management procedure, the wireless network comprising:
access points capable of sending to a wireless device a uniform resource identifier based configuration message comprising a provider-specific identity string,
wireless terminals which are capable of:
receiving a configuration message addressed to it,
interpreting said provider-specific identity string included in the configuration message, and
when said provider-specific identity string has been detected, concatenating the received provider-specific identity string and a supplier-specific internal identity string of the wireless device as a concatenated client identity string, and
using the concatenated client identity string in communication with the access point, which sent the configuration message.

26. The device management system according to claim 25 wherein the concatenated client identity has a formula:
ClientID=[<CIDPrefix>+“##”+]<Internal ClientID>,
where the CIDPrefix includes the provider-specific identity string.

27. A computer program product for a wireless device utilizing OMA Device Management protocol, the computer program comprising:
a computer-readable code means for receiving a provider-specific identity string included in a configuration message from a server to the wireless device,
a computer-readable code means for interpreting said configuration message,
a computer-readable code means for concatenating the provider-specific identity string and a supplier-specific identity string when said provider-specific identity string is detected, and
a computer-readable code means for using the concatenated client identity string in communication with the server which sent the configuration message.

28. The computer program product according to claim 27 wherein the means for concatenating the provider-specific identity string and the supplier-specific identity string comprises:
a computer-readable code means for adding separation marks after the received provider-specific identity string,
a computer-readable code means for adding the supplier-specific internal identity string of the wireless device after the separation marks, and
a computer-readable code means for saving the created concatenated client identity string in the wireless device.

29. A computer program product for a server to update a wireless device by utilizing OMA Device Management protocol, the computer program comprising:
a computer-readable code means for creating a provider-specific identity string to be included in a configuration message, and
a computer-readable code means for receiving a concatenated client identity string from the wireless device, the concatenated identity string comprising:
the provider-specific identity string
a separator part after the provider-specific identity string value, and
a supplier-specific internal identity string of the wireless device after the separator part.

30. The computer program product according to claim 29 wherein the concatenated client identity string has a formula:
ClientID=[<CIDPrefix>+“##”+]<Internal ClientID>,
where the CIDPrefix includes the provider-specific identity string.
